(19) United States
(12) Patent Application Publication
(10) Pub. No.: US 2011/0222078 A1
(43) Pub. Date: Sep. 15, 2011

(54) IMAGE PROCESSING APPARATUS, OPERATION MODE SETTING METHOD THEREFOR, AND RECORDING MEDIUM

(75) Inventors: Eiichi YOSHIDA, Toyokawa-shi (JP); Tsumoru Matsuura, Toyohashi-shi (JP); Kenichi Komaba, Toyokawa-shi (JP); Takatsugu Kuno, Toyokawa-shi (JP); Taketoshi Yamahata, Toyokawa-shi (JP)

(73) Assignee: Konica Minolta Business Technologies, Inc., Chiyoda-ku (JP)

(21) Appl. No.: 13/045,154

(22) Filed: Mar. 10, 2011

(30) Foreign Application Priority Data
Mar. 12, 2010 (JP) 2010-056458

(51) Int. Cl. G06K 15/02; G06F 3/12

(52) U.S. Cl. 358/1.2; 358/1.13

(57) ABSTRACT

An image processing apparatus comprises a display; a customization portion; a mode setting portion; and a controller that forcibly changes a value set for a first operation mode to a first parameter, still keeps the first parameter after cancellation of the second operation mode, and changes the first parameter according to a user operation, if a second operation mode is employed by the mode setting portion while an operation key for setting a value for the first operation mode is not hidden by the customization portion, meanwhile changes the value set for the first operation mode to a second parameter and changes the second parameter to a third parameter after cancellation of the second operation mode, if the second operation mode is employed by the mode setting portion while an operation key for setting a value for the first operation mode is hidden by the customization portion.

This application claims priority under 35 U.S.C. §119 to Japanese Patent Application No. 2010-056458 filed on Mar. 12, 2010, the entire disclosure of which is incorporated herein by reference in its entirety.

### BACKGROUND OF THE INVENTION

1. Technical Field

The present invention relates to an image processing apparatus that allows users to perform customization so that an operation key for setting an operation mode will or will not appear on a screen on a display of, for example, an operation panel; an operation mode setting method for the image processing apparatus; and a computer-readable recording medium having an operation mode setting program stored thereon to make a computer of the image processing apparatus execute processing.

2. Background Technology

The following description sets forth the inventor's knowledge of related art and problems therein and should not be construed as an admission of knowledge in the prior art.

For recent years, the image processing apparatuses such as the multifunctional digital image forming apparatuses referred to as MFPs (Multi Function Peripherals) have gotten lots of features, and such an image processing apparatus allows users to set an operation mode for a preferable feature when an operation key for setting that feature is selected among those displayed on a display of an operation panel thereof.

Most of users tend to use only basic ones among lots of features installed on the image processing apparatus, or they unconsciously use some fixed ones among those, depending on their environment including the image processing apparatus or their jobs there. However, with too many operation keys on a display screen on the operation panel, including necessary and unnecessary ones laid out in a mixed manner, it is quite troublesome to differentiate one from another and perform more operations to complete setting a target feature.

To resolve this inconvenience, as described in Japanese Patent Publications No. 2002-361986 and No. 2007-249863, there are technologies about customization of the setting whether or not to display an operation key on a display screen on the operation panel, and with these technologies, unnecessary operation keys can be removed from the display screen.

And, as described in Japanese Patent Publication No. H07-160148, there is a mode setting method for an image forming apparatus with the auto-select paper mode for automatically selecting paper depending on document size and a copy scale specified via a scale entry portion; and the auto-adjust scale mode for automatically adjusting a copy scale depending on paper size specified via a paper selection portion and document size, and with this mode setting method, if receiving an entry via the paper selection portion while the auto-select paper mode is employed, the image forming apparatus changes its copy mode from the auto-select paper mode to the auto-adjust scale mode.

Furthermore, as described in Japanese Patent Publication No. 2000-276010, there is an image forming apparatus with a plurality of image forming modes, including: a selection portion that selects preferable ones among the image forming modes; a display that displays a list of the selected image forming modes; and a judgment portion that judges whether or not the selected image forming modes can be employed at the same time, and wherein if the judgment portion judges that the image forming modes cannot be employed at the same time, such a notice is also displayed on the display while the list is displayed thereon.

However, the conventional image processing apparatus that allows users to perform customization so that an operation key will or will not appear on a screen as described above causes the troubles to be described below depending on a category of the operation key, while the operation key is hidden because of customization.

A specific feature (mode) is assigned to every operation key. However, the image processing apparatuses such as multifunctional digital image forming apparatuses also have gotten lots of applied features to facilitate image forming, and some operation keys for setting these applied features are mutually affected to each other.

For example, the N-in-1 printing mode (such as 2-in-1 or 4-in-1 mode) to print multiple pages (N pages) of a document perfectly on one sheet of paper and the booklet mode are often used at office from a standpoint of eco-friendliness or cost-saving, but it is quite troublesome that images on a document may partially be missing on printed paper in the N-in-1 printing mode without adjusting the scale of image to the N-in-1 form. In general, with pressing an operation key for setting the N-in-1 printing mode, the scale of image is forcibly set to a predetermined value (for example, forcibly set to “70.7%” in the 2-in-1 mode).

However, the scale of image is never reset to the default value automatically, even after cancellation of the N-in-1 printing mode. The scale of image still remains as is since there is a “Scale” key and the user might try to change the scale of image using this operation key, only to decide with the same value after all.

However, if the user has performed customization to hide the “Scale” key, he/she never can reset the scale of image to the default value using this key even after cancellation of the N-in-1 printing mode; the scale of image still remains as is against his/her intention. This is quite troublesome, too.

The same trouble also occurs in other cases as well as in the cases with the N-in-1 printing mode and the scale setting mode. For example, when the book style document mode to read and copy text in a book is employed, the original image quality may be forcibly set to “Penciled (Light Tone Text)”. And similar to the case presented above, unless the user uses an operation key for setting original image quality, the original image quality still remains as “Penciled (Light Tone Text)” even after cancellation of the book style document mode.

However, if the user has performed customization to hide an operation key for setting original image quality, he/she cannot reset the set value to the default one using this key after cancellation of the book style document mode. This is also quite troublesome.

Unfortunately, the Japanese Patent Publications presented above cannot be an effective solution to these troubles.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image processing apparatus that is capable of resolving the trouble that if a second operation mode is employed and thereby a value set for a first operation mode is forcibly changed to a different one while an operation key for setting the first operation mode is not displayed because of customization, the different value can never be reset even after cancellation of the second operation mode.

It is another object of the present invention to provide an operation mode setting method for the image processing apparatus.

It is still another object of the present invention to provide a computer-readable recording medium having an operation mode setting program stored thereon to make a computer of the image processing apparatus implement the operation mode setting method.

According to a first aspect of the present invention, an image processing apparatus includes:

a display;

a customization portion that allows performing customization so that one or more than one operation key for setting an operation mode will or will not appear on the display;

a mode setting portion that allows employing operation modes including a first operation mode, and a second operation mode forcibly canceling a value set for the first operation mode; and

a controller that forcibly changes the value set for the first operation mode to a first parameter, still keeps the first parameter after cancellation of the second operation mode, and changes the first parameter according to a user operation, if the second operation mode is employed by the mode setting portion while an operation key for setting a value for the first operation mode is not hidden by the customization portion, meanwhile changes the value set for the first operation mode to a second parameter and changes the second parameter to a third parameter after cancellation of the second operation mode, if the second operation mode is employed by the mode setting portion while an operation key for setting a value for the first operation mode is hidden by the customization portion.

According to a second aspect of the present invention, an operation mode setting method for an image processing apparatus includes:

performing customization so that one or more than one operation key for setting an operation mode will or will not appear on a display;

employing operation modes including a first operation mode, and a second operation mode forcibly cancelling the value set for the first operation mode; and

forcibly changing the value set for the first operation mode to a first parameter, still keeping the first parameter after cancellation of the second operation mode, and changing the first parameter according to a user operation, if the second operation mode is employed while an operation key for setting a value for the first operation mode is not hidden, meanwhile changing the value set for the first operation mode to a second parameter and changing the second parameter to a third parameter after cancellation of the second operation mode, if the second operation mode is employed while an operation key for setting a value for the first operation mode is hidden.

According to a third aspect of the present invention, a computer-readable recording medium has an operation mode setting program to make a computer of an image processing apparatus execute:

performing customization so that one or more than one operation key for setting an operation mode will or will not appear on a display;

employing operation modes including a first operation mode, and a second operation mode forcibly cancelling the value set for the first operation mode; and

forcibly changing the value set for the first operation mode to a first parameter, still keeping the first parameter after cancellation of the second operation mode, and changing the first parameter according to a user operation, if the second operation mode is employed while an operation key for setting a value for the first operation mode is not hidden, meanwhile changing the value set for the first operation mode to a second parameter and changing the second parameter to a third parameter after cancellation of the second operation mode, if the second operation mode is employed while an operation key for setting a value for the first operation mode is hidden.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram schematically illustrating a configuration of a MFP that is an image processing apparatus according to one mode of implementing the present invention;

FIG. 2 is a block diagram of a controller thereof;

FIG. 3 is a plain view of an operation panel thereof;

FIG. 4 is a plain view of the operation panel without a specific operation key being thereon;

FIG. 5 is a view illustrating a screen mapping table [T-1];

FIG. 6 is a view illustrating a key information table [T-2];

FIG. 7 is a view illustrating a mode mapping table [T-3];

FIG. 8 is a view illustrating a key display OFF mode management table [T-4];

FIG. 9 is a plain view of an operation panel to describe how to perform customization so that an operation key will or will not appear on a screen;

FIG. 10 is a plain view of an operation panel on which an item selection screen is displayed;

FIG. 11 is a plain view of an operation panel on which a key selection screen is displayed;

FIG. 12A is a plain view of an operation panel on which a mode selection screen is displayed, and FIG. 12B is a plain view of an operation panel on which a scale change screen is displayed;

FIG. 13 is a view illustrating a key display OFF mode optimization table [T-5];

FIG. 14 is a flowchart representing a main routine executed by a MFP;

FIG. 15 is a flowchart representing a subroutine that is an operation panel process (Step #1) from the flowchart of FIG. 14;

FIG. 16 is a flowchart representing a subroutine that is a mode setting process (Step #13) from the flowchart of FIG. 15;

FIG. 17 is a flowchart representing a subroutine that is a mode setting process of Step #133 in FIG. 16, which is executed if there is a hidden key;

FIG. 18 is a flowchart representing a subroutine that is a regular mode setting process of Step #134 in FIG. 16; and

FIG. 19 is a flowchart representing a subroutine that is a key display OFF setting process of Step #136 in FIG. 16.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one of the best modes of implementing the present invention will be described with reference to the accompanying drawings.

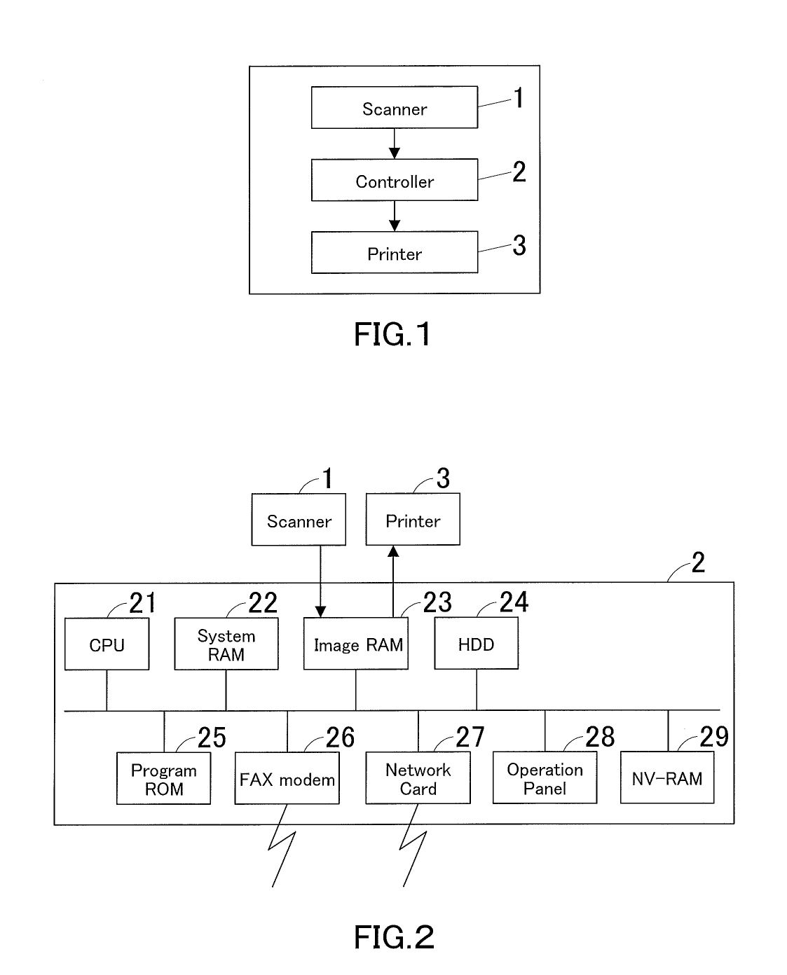

FIG. 1 is a block diagram schematically illustrating a configuration of a MFP that is an image processing apparatus according to one mode of implementing the present invention. In this mode of embodied implementation, as an image processing apparatus, a MFP that is a multifunctional image forming apparatus collectively having the copy function, the print function, the facsimile (FAX) function, the scanning function, the memory function, and the like is employed.

The MFP includes a scanner 1 that reads an image on a document by a sensor such as a CCD, a controller 2 that executes processing on data such as a digital image, and a printer 3 that prints an image on paper.

FIG. 2 is a block diagram of the controller 2.

The controller 2 includes a CPU 21, a system RAM 22, an image RAM 23, a hard disk drive (HDD) 24, a program ROM 25, a FAX modem 26, a network card 27, an operation panel 28, a nonvolatile RAM (NV-RAM) 29, and the like.

The CPU 21 integrally controls the MFP to make it execute the copy function, the print function, the facsimile function, and the like. Also, the CPU 21 employs an operation mode set by users via an operation panel 28 and makes a display of the operation panel 28 hide a specific operation key.

The system RAM 22 stores data for the CPU 21 to execute processing according to an operation program and temporarily stores information while the operation program is running.

The image RAM 23 stores image data optically read out from a document by the scanner 1.

The HDD 24 is a storage that stores various types of data such as image data, applications, and the like, and the program ROM 25 stores an operation program for the CPU 21 to run. The program ROM 25 also stores: a program to control display and key entry operations of the operation panel 28; graphic data to display operation keys on the operation panel 28; “key management information” to determine how to act with pressing of operation keys; and the like.

The FAX modem 26 serves as a FAX transmitter/receiver, the network card 27 serves as an interface that performs communication with an external device, and the NV-RAM 29 stores nonvolatile information entered by users.

In this configuration presented above, image data optically read out from a document by the scanner 1 is stored on the image RAM 23. The image data stored on the image RAM 23 is transferred to the printer 3 and printed out thereby.

When executing the copy function, the image data optically read out by the scanner 1 is temporarily stored on the image RAM 23 then transferred to the printer 3 and printed out thereby. When executing the scanning function, the image data optically read out by the scanner 1 is temporarily stored on the image RAM 23 then read out and encoded into a widely-used image format by the CPU 21, and then transmitted to an external device by e-mail or FTP via the network card 27.

When executing the FAX transmission function, the image data optically read out by the scanner 1 is temporarily stored on the image RAM 23 then converted into a resolution and a compression format suitable for FAX transmission by the CPU 21, and then transferred to an external device via the FAX modem 26.

When executing the FAX receiving function, the image data received via the FAX modem 26 is temporarily stored on the image RAM 23 then converted into a suitable format for printing by the CPU 21, and then transferred to the printer 3 and printed out thereby.

When executing the print function, the page-description language received from the network by the network card 27 is decompressed by the CPU 21 and stored on the image RAM 23, and then transferred to the printer 3 and printed out thereby.

The image data can be transferred and printed out over and over again, only if it is stored in advance on the HDD 24. The image data is transferred from the image RAM 23 to the HDD 24 and stored on the HDD 24, when an instruction to store the image data is given.

Since the above-described operations of the MFP, such as an image forming operation, is a publicly-known technology of a MFP, those need not further be described herein.

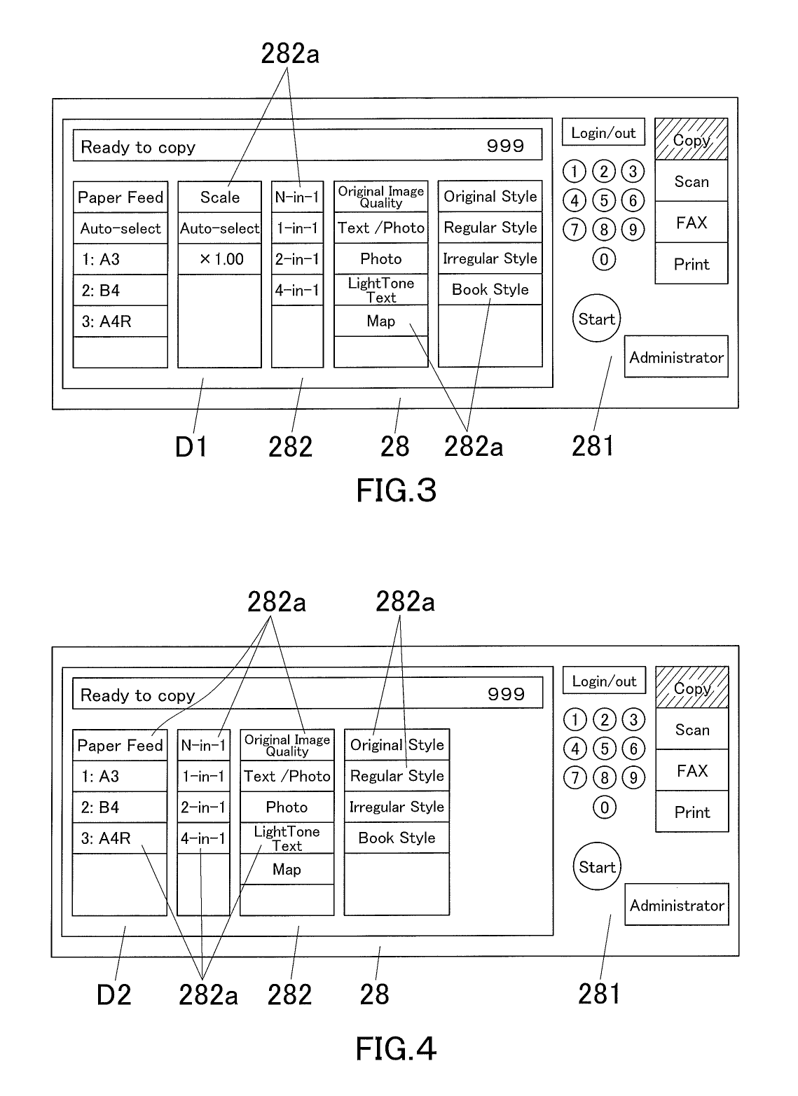

FIG. 3 is a plain view of the operation panel 28. The operation panel 28 includes: a hardware keyboard 281 that has a Start key, a numeric keypad, a Scan key, a Copy key, a FAX key, a Print key, and the like thereon; and a display 282 that contains liquid-crystal elements and the like. The display 282 displays a mode setting screen with one or more than one operation key 282a for setting an operation mode. Users operate the MFP by pressing hardware keys provided on the hardware keyboard 281 of the operation panel 28 and software keys that are the operation keys 282a displayed on the display 282.

The MFP according to one mode of embodied implementation allows users to perform customization to change the value “Display ON” set for a specific operation key, to “Display OFF”. Because of the customization, the specific operation key will not appear on a screen, and users do not have to bother selecting among so many features.

For example, FIG. 3 illustrates a copy mode setting screen D1 with an “Auto-select Tray” key and a “Scale of Image” key (also will be referred to simply as “Scale” key) being thereon, before customization. FIG. 4 illustrates a copy mode setting screen D2 without these keys that appeared on the screen of FIG. 3, being thereon, after customization. As illustrated in this Figure, users can adjust their operation environment to the range of their practical use, by performing customization so that specific operation keys, for example the “Auto-select Tray” key and the “Scale” key will not appear thereon.

Hereinafter, how to change the setting of a preferable operation key from display to non-display will be described.

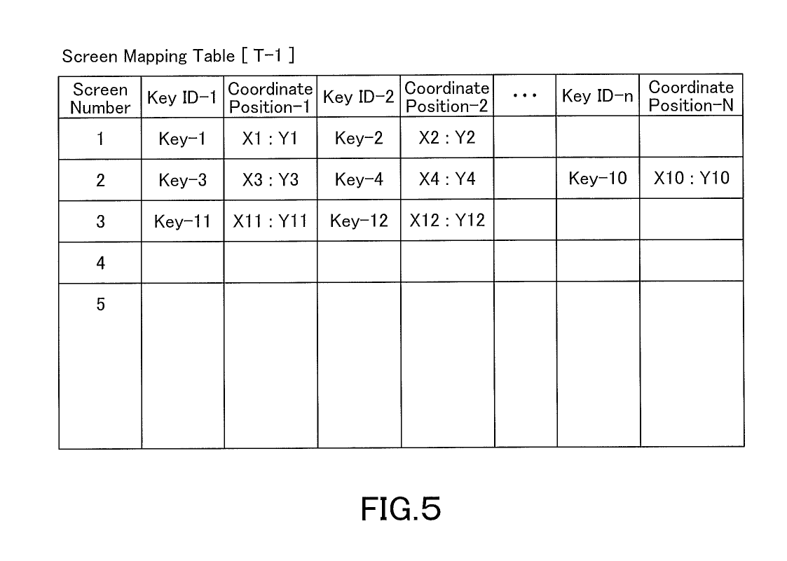

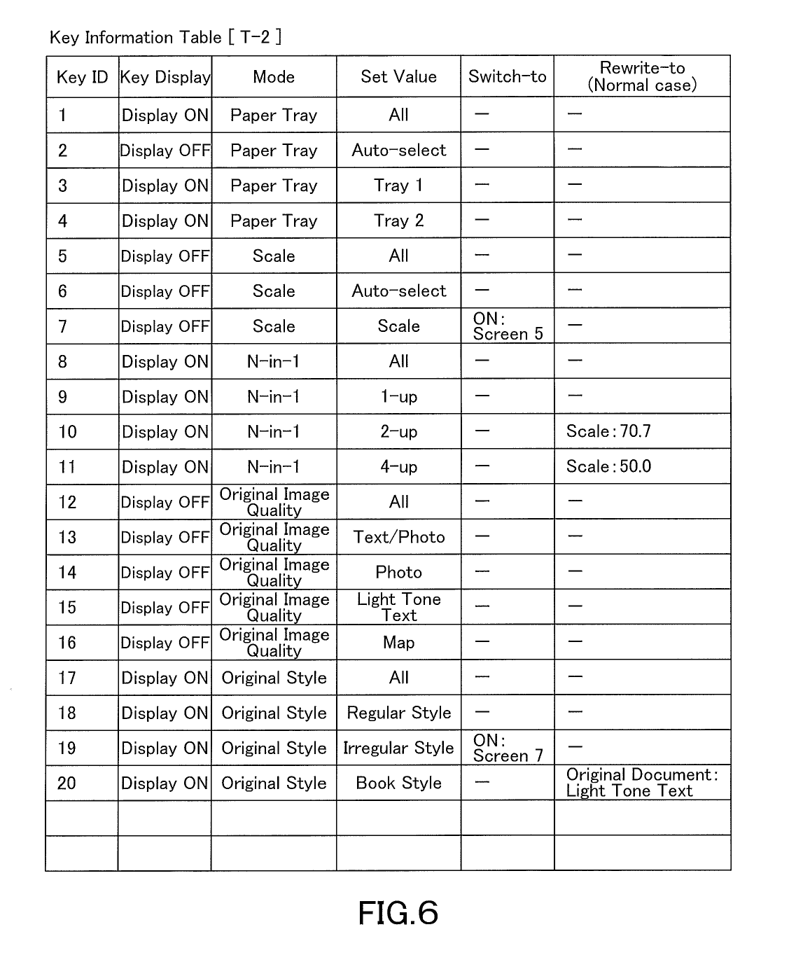

The NV-RAM 29 stores information of operation keys on screens. The information is constructed of a screen mapping table [T-1] illustrated in FIG. 5 and a key information table [T-2] illustrated in FIG. 6.

A plurality of screens are displayed on the display 282 of the operation panel 28, and as described above, users can perform customization to hide operation keys on the screens. Settings for operation keys on the screens are recorded in the screen mapping table [T-1].

The screen mapping table [T-1] includes information of operations keys on each of the screens and information of the operation keys' positions. The number of operation keys depends on a screen.

The key information table [T-2] illustrated in FIG. 6 includes key IDs.

In the key information table [T-2], “Key ID” refers to a number internally given to identify an operation key. Meanwhile, display information used by the display 282, such as shapes and sizes of operation keys is stored in advance on the program ROM 25, and the operation keys are displayed on screens in the shapes and sizes indicated by the display information, and which operation keys are pressed is judged based on their sizes, and the coordinate positions recorded in the screen mapping table [T-1].

The value set in the field of “Key Display”, which is set by users and recorded in the table determines whether or not to display operation keys on screens. The operation keys having the value “Display OFF” in this field will not appear on screens. The value “Display OFF” is written in this field when customization of the operation keys is performed. In this mode of embodied implementation, there are some operation keys having the parameter “All” in the field of “Set Value” as to be described herein later. The value “All” means all operation keys that belong to an operation mode, and while such an operation key has the value “Display OFF” in the field of “Key Display”, all operation keys that belong to the operation mode will not appear on screens, neither. For example, according to the key information table [T-2] of FIG. 6, all operation keys that belong to the operation modes of “Scale of Image” (also referred to simply as “Scale”) and “Original Image Quality” will not appear on screens, because the operation key with the key ID 5 for setting a scale and the operation key with the key ID 12 for setting original image quality have the value “All” in the field of “Set Value”. Therefore, users cannot set these operation modes. The key IDs are provisional numbers having no meanings.

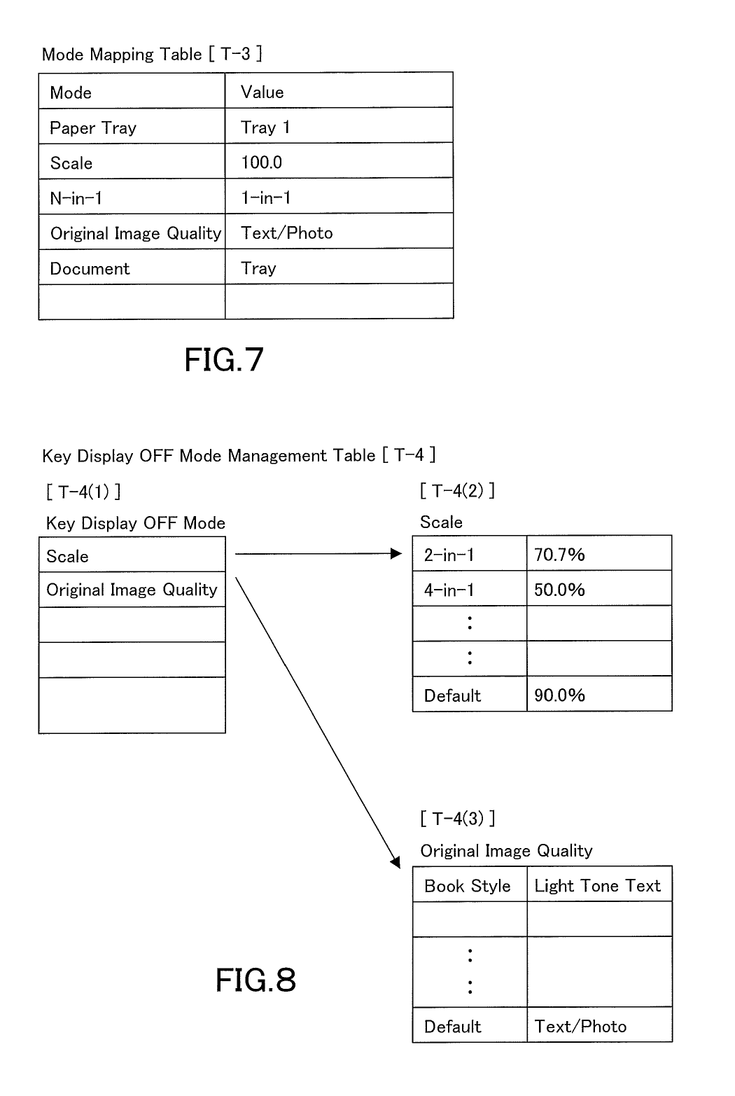

In the key information table [T-2], “Mode” refers to an operation mode assigned to an operation key, and “Set Value” refers to a value set for the operation mode. Meanwhile, a mode mapping table [T-3] (illustrated in FIG. 7) includes a collection of operation modes and values set for the operation modes for the MFP to perform operations, and this table is stored on the system RAM 22.

For example, when pressing the operation key with the key ID 3, the value “Tray 1” will be written in the field of “Paper Tray” in the mode mapping table [T-3] illustrated in FIG. 7, since the value “Tray 1” is already written in the field of “Paper Tray” in the key information table [T-3] illustrated in FIG. 6. Since it is a well-known technology to provide a MFP that forms an image according to the mode mapping table [T-3], it is not described herein.

In the key information table [T-2] of FIG. 6, “Switch-to” refers to whether or not to go to a next screen with pressing of the operation key and the screen ID of the next screen. To display a next screen, the display control operation is performed again with use of the screen mapping table [T-1] and the key information table [T-2], as described above.

As for “Rewrite-to” in the key information table [T-2] of FIG. 6, with pressing of an operation key having information in the field of “Rewrite-to”, a value having been set using a different key is forcibly written to the information in the field of “Rewrite-to”. This rewriting operation is performed only while the value “Display ON” is written in the field of “Key Display” about the different operation key.

### Operative Example 1

### A Case where an Operation Key is Set to “Display ON”

According to the table of FIG. 6, with pressing of the operation key with the key ID 10, the 2-in-1 mode is employed and the scale is forcibly changed to “70.7%” so as to prevent images from being partially missing. On the other hand, in the example of FIG. 6, the scale is not forcibly changed to “70.7%” against the table of FIG. 6, because the value “All” is written in the field of “Scale” and the value “Display OFF” is written in the field of “Key Display” about the operation key with the key ID 5. However, while the value “Display ON” is written in the field of “Key Display” about this operation key in the table of FIG. 6, the value “70.7” is written in the field of “Scale” in the mode mapping table [T-3] of FIG. 7. The scale is forcibly changed in this way above, because an operation error may occur without doing so. In general, by reducing the scale by 70.7%, if the sizes of a document and print paper are the same, images of the document is printed out perfectly on one sheet of paper in the 2-in-1 mode.

While the value “Display ON” is written in the field of “Key Display” about the operation key with the key ID 5, the scale still remains as “70.7%” even after the 2-in-1 mode is canceled by a user's pressing of another operation key. Users may change the value of scale using the “Scale” key.

### Operative Example 2

### A Case where an Operation Key is Set to “Display ON”

According to the table of FIG. 6, with pressing of the operation key with the key ID 20, the book style document mode is employed and the original image quality is forcibly changed to “Light Tone Text” so as to optimize image quality. On the other hand, in the example of FIG. 6, the original image quality is forcibly changed to “Light Tone Text” against the table of FIG. 6, because the value “All” is written in the field of “Original Image Quality” and the value “Display OFF” is written in the field of “Key Display” about the operation key with the key ID 12. However, while the value “Display ON” is written in the field of “Key Display” about this operation key in the table of FIG. 6, the value “Light Tone Text” is written in the field of “Original Image Quality” in the mode mapping table [T-3] of FIG. 7. The original image quality is forcibly changed in this way above, because people often make a copy of a notebook including penciled text by the book style document mode. While the value “Display ON” is written in the field of “Key Display” about the operation key with the key ID 20, users can arbitrarily change the original image quality using this operation key.

While the value “Display ON” is written in the field of “Key Display” about the operation key with the key ID 12, the original image quality still remains as “Light Tone Text” even after the book style document mode is canceled by a user's pressing of another operation key. Users may change the original image quality using the operation key.

As described above, in the example of FIG. 6, all operation keys that belong to the operation modes of “Scale” and “Original Image Quality” will not appear on screens according to the table. A key display OFF mode management table [T-4] to define an attitude in such a case is stored on the NV-RAM 29. Tables are created for these operation modes individually and the key display OFF mode management table [T-4] is a consolidation of them.

FIG. 8 is a view illustrating an example of a key display OFF mode management table [T-4].

In FIG. 8, all operation keys that belong to the operation modes of “Scale” and “Original Image Quality” will not appear on screens. When all operation keys that belong to these operation modes are set to “Display OFF”, a key display OFF mode management table [T-4] as illustrated in FIG. 8 will be created for each of the modes.

Default values will be copied from the program ROM 25 into the NV-RAM 29. Users may change the values.

The key display OFF mode management table [T-4] is constructed of a non-display mode table [T-4(1)], a scale table [T-4(2)], and an original image quality table [T-4(3)]. The non-display mode table [T-4(1)] includes these operation modes in list form, the scale table [T-4(2)] includes printing modes and specific values for the printing modes in list form, and the original image quality table [T-4(3)] includes image quality modes and specific values for the image quality modes in list form.

Users may change the value set for an operation key while the operation key is set to “Display ON”, but cannot change it while the operation key is set to “Display OFF”. In order to perform an operation in a specified operation mode in an optimal manner even while the operation keys for setting a scale of image and original image quality are set to “Display OFF”, the MFP changes the set values to predetermined ones according to the scale table [T-4(2)] and the original image quality table [T-4(3)], respectively. There are always default values in the scale table [T-4(2)] and the original image quality table [T-4(3)], and the MFP will employ the default values if there is no predetermined value for the specified operation mode in these tables.

When a user changes an operation mode by pressing an operation key for setting the operation mode, the MFP will search the tables for a predetermined value for the new operation mode and write the value into the above-described mode mapping table [T-3] of FIG. 7. In this way, the new operation mode is optimally set even while an operation key for setting the operation mode is set to “Display OFF”.

An operative example will be described herein below.

### Operative Example 1

### A Case where an Operation Key is Set to “Display OFF”

When a user selects the 2-in-1 mode while the “Scale” key is set to “Display OFF”, the MFP will refer to the scale table [T-4] of FIG. 8. Since the value “70.7%” is written in the field of “2-in-1” in this table, this value is employed as the scale of image for the 2-in-1 mode. Although, by chance, it is the same value (70.7%) as the one forcibly set for the operation mode according to FIG. 6, it may be a different one.

When the user cancels the 2-in-1 mode and selects a different operation mode, a predetermined value for the different operation mode will be set according to the scale table [T-4(2)]. If there is no predetermined value for the different operation mode in the scale table [T-4(2)], the default value 90.0% will be employed. It has been inconvenient that the scale still remains as “70.7%” even after cancellation of the 2-in-1 mode and a next operation is performed with the inappropriate value, but the inconvenience can be eliminated as described above in this example.

There is a possibility that many users may use a document that is filled with images until the edges of its paper, and with consideration of the possibility in this example, the default value of scale is 90.9%, a little bit lower than 100%. Users may change the values in the table.

### Operative Example 2

### A Case where an Operation Key is Set to “Display OFF”

When a user selects the book style document mode while the Original Image Quality is set to “Display OFF”, the MFP will refer to the original image quality table [T-4(3)] of FIG. 8. Since the value “Light Tone Text” is written in the field of “Book Style” in this table, this value is employed as the original image quality for the book style document mode.

When the user cancels the book style document mode and selects a different operation mode, a predetermined value for the different operation mode will be set according to the original image quality table [T-4(3)]. If there is no predetermined value for the different operation mode in the scale table [T-4(3)], the default value “Text/Picture” will be employed. Although it has been inconvenient that the original image quality still remains as “Light Tone Text” even after cancellation of the book style document mode and a next operation is performed with the inappropriate value, the inconvenience can be eliminated as described above in this example. Users may change the values in the table.

Hereinbelow, how to customize a display screen on the operation panel 28 will be described.

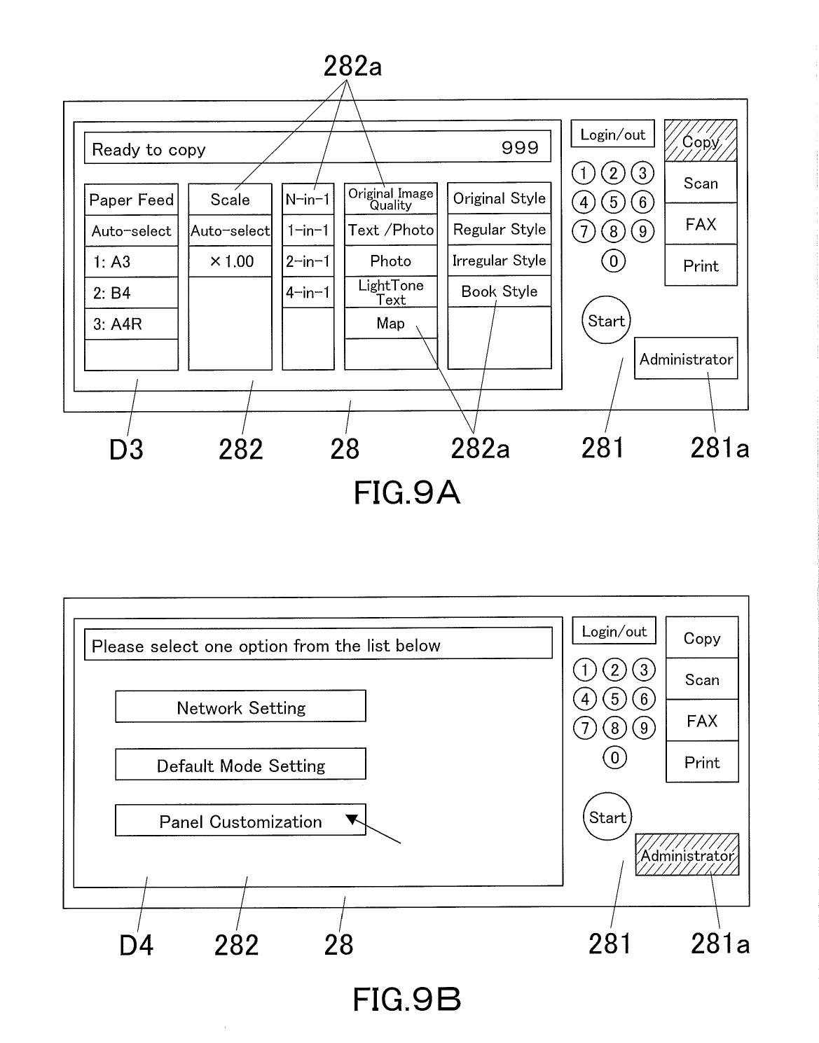

With pressing of an “Administrator” key 281a on the operation panel 28 as illustrated in FIG. 9A, the MFP turns to the administrator mode and displays a menu selection screen D4 as illustrated in FIG. 9B. Usually, the procedure has to start with a process of authorizing users with an entry of, for example a password, the process is skipped.

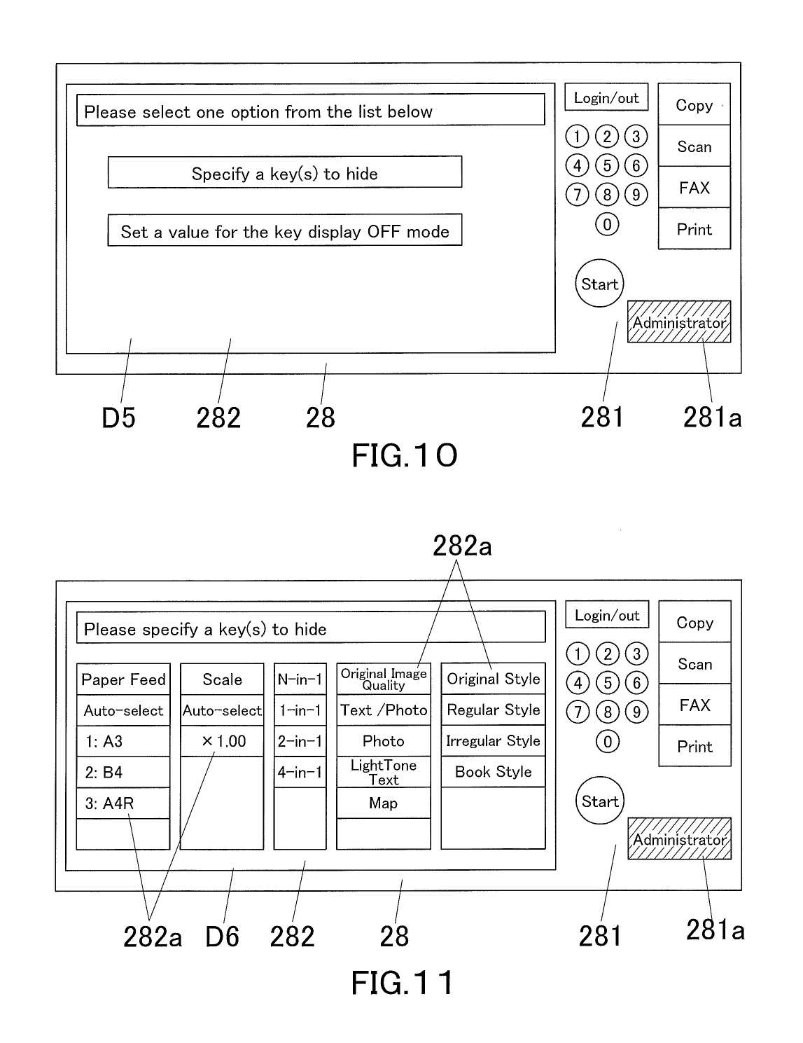

With pressing of a “Panel Customization” button among those displayed on the menu selection screen D4 of FIG. 9B, the screen is switched to an item selection screen D5 as illustrated in FIG. 10. On this screen, a “Specify a key(s) to hide” button for selecting operation keys to hide and a “Set a value for the key display OFF mode” button for setting a value about an operation key to be hidden.

With pressing of the “Specify a key(s) to hide” button, the screen is switched to a key selection screen D6 as illustrated in FIG. 11. Selecting selection keys 282a to hide via the screen, customization is properly completed.

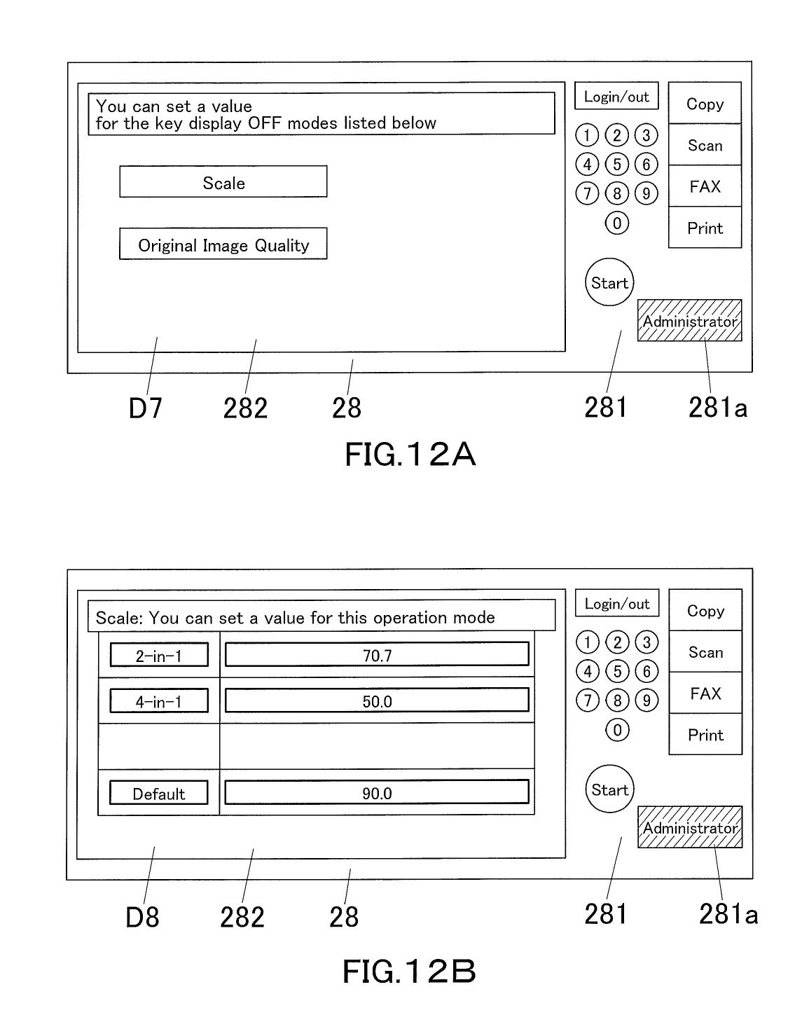

Meanwhile, with pressing of the “Set a value for the key display OFF mode” button on the item selection screen D5 of FIG. 10, the screen is switched to a mode selection screen D7 as illustrated in FIG. 12A. On this screen, there are the selection buttons, the “Scale” button for setting a scale and the “Original Image Quality” button for setting original image quality.

With pressing of the “Scale” button for example, on the mode selection screen D7 of FIG. 12A, the screen is switched to a value-of-scale change screen D8 as illustrated in FIG. 12B. Via this screen, a value, and also a default value can be arbitrarily set for every scale-related operation mode, such as the 2-in-1 mode and the 4-in-1 mode. And the values set via this screen are reflected to the scale table [T-4(2)] included in the key display OFF mode management table [T-4].

Similarly, with pressing of the “Original Image Quality” button on the mode selection screen D7 of FIG. 12A, a value can be arbitrarily set for various operation modes in connection with Original Image Quality. And the value set via the screen is reflected to the original image quality table [T-4(3)].

As described above, in this mode of embodied implementation, since optimal values may depend on usage, users can arbitrarily change set values in the scale table [T-4(2)] and the original image quality table [T-4(3)] which are included in the key display OFF mode management table [T-4].

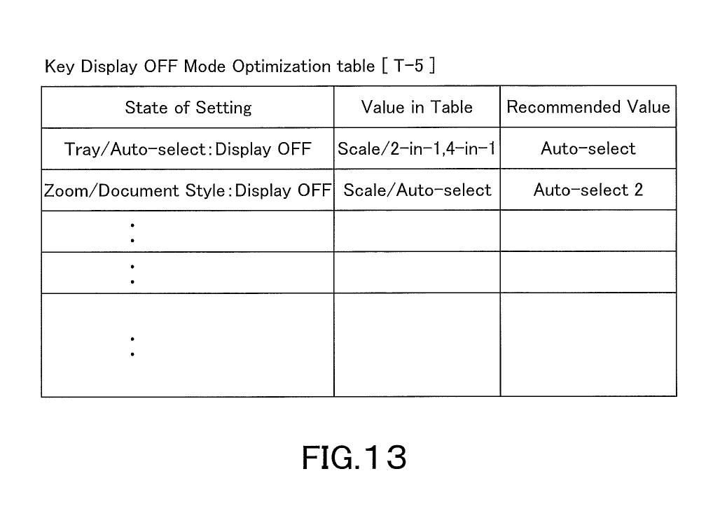

Furthermore, in this mode of embodied implementation, since optimal values may depend on usage, a key display OFF mode optimization table [T-5] (as illustrated in FIG. 13) that serves to facilitate users' setting operation is stored on the program ROM 25, and with use of this table, users can easily optimize values set for operation modes that are assigned to operation keys to be hidden because of customization.

For example, while an operation key for setting the auto-select tray mode is set to “Display OFF”, users would feel much easier if optimal values of scale are automatically set for the 2-in-1 mode and the 4-in-1 mode. Therefore, if the practical state of setting matches any one of this table, values recommended for the state in this table will be automatically written into the key display OFF mode management table [T-4]. Users may change the values written in the table [T-4].

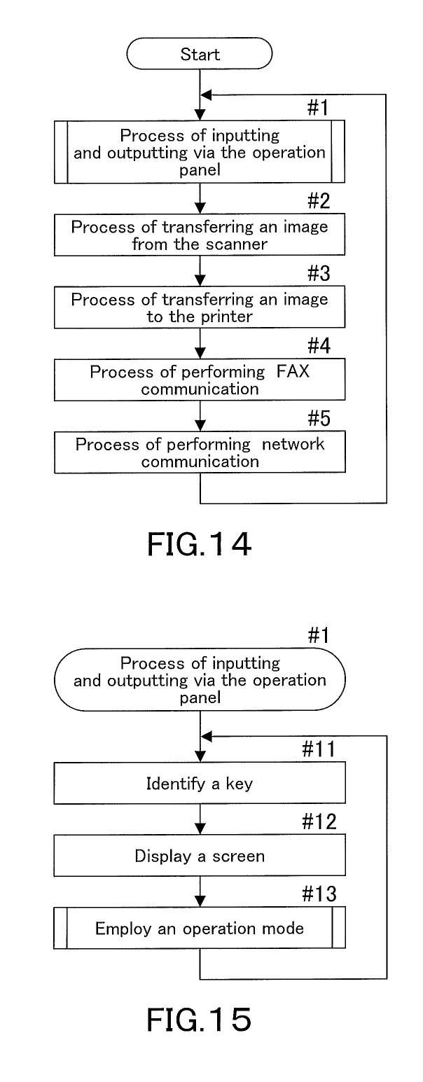

Hereinafter, a procedure executed by the MFP will be described with reference to flowcharts illustrated in FIG. 14 through FIG. 19. The procedure is executed by the CPU 21 according to an operation program stored on the program ROM 25.

FIG. 14 is a flowchart representing a main routine that starts when the MFP is powered on and sequentially repeats: the process of inputting and outputting via the operation panel 28 (Step #1); the process of transferring an image from the scanner 1 to the image RAM 23 (Step #2); the process of transferring an image from the image RAM 23 to the printer 3 (Step #3); the process of performing facsimile communication (Step #4); and the process of performing network communication (Step #5).

FIG. 15 is a flowchart representing a subroutine that is the process of performing input and output operations (Step #1), from the flowchart of FIG. 14.

In Step #11, the pressing of a hardware key, or a software key (operation key) on the display 282 is detected, and its key ID is identified (Step #11). Subsequently, a screen to be displayed thereon is created according to the screen mapping table [T-1], and the key information table [T-2] and the created screen is displayed on the display 282 (Step #12). And an operation mode is employed according to a user operation using operation keys (Step #13).

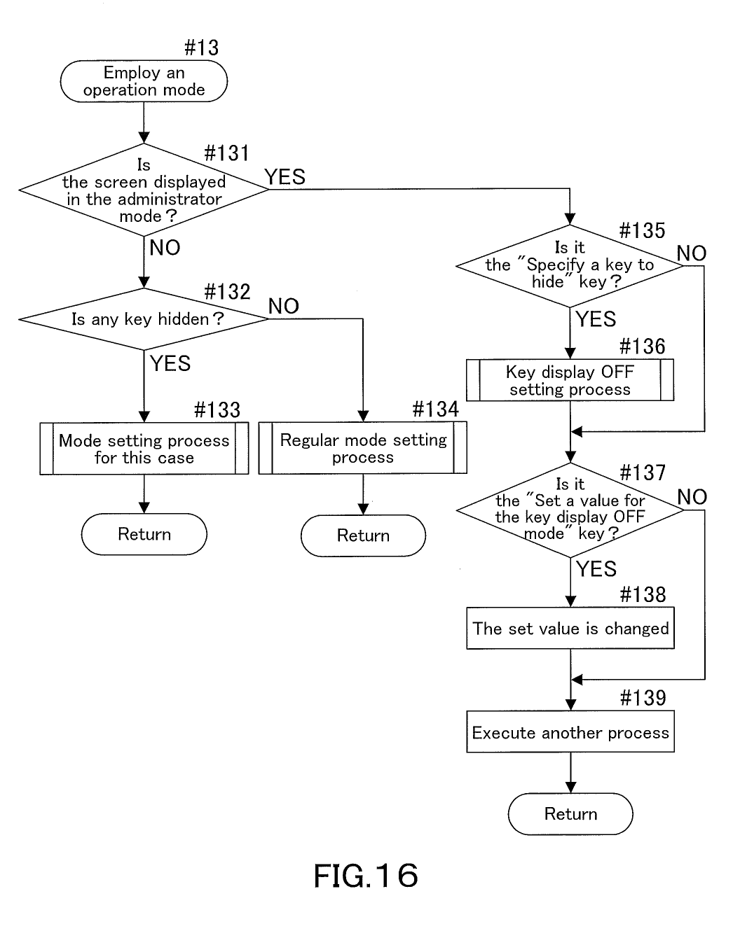

FIG. 16 is a flowchart representing a subroutine that is the process of setting an operation mode (Step #13), from the flowchart of FIG. 15.

In Step #131, it is judged whether or not the screen is displayed in the administrator mode. If the screen is displayed in the administrator mode (YES in Step #131), the pressed key is identified and a suitable process is executed accordingly.

In other words, it is judged in Step #135, whether or not it is the “Specify a key to hide” key on the item selection screen D5 (as illustrated in FIG. 10). If it is the “Specify a key(s) to hide” key (YES in Step #135), a key is specified and set to “Display OFF” in Step #136, and then the routine goes to Step #137. In this process, an operation key is specified and set to “Display OFF”, and values set about this operation key in the key information table [T-2], the key display OFF mode management table [T-4], and the key display OFF mode optimization table [T-5] are changed.

In Step #135, if it is not the “Specify a key(s) to hide” key (NO in Step #135), the routine immediately goes to Step #137. In Step #137, it is judged whether or not it is the “Set a value for the key display OFF mode” key. If it is the “Set a value for the key display OFF mode” key (YES in Step #137), the set value is changed in Step #138. In this process, a value having been set using an operation key that is now hidden because of customization is changed, i.e. the key display OFF mode management table [T-4] is updated.

In Step #137, if it is not the “Set a value for the key display OFF mode” key (NO in Step #137), another process is executed in Step #139. After that, the subroutine returns to the main routine.

In Step #131, if the screen is not displayed in the administrator mode, in other words, if the screen is displayed in the regular mode (NO in Step #131), then it is judged in Step #132, whether or not any operation key is hidden behind the screen because of customization (this key also will be referred to as hidden key). The examination on whether or not there is any hidden key is conducted with reference to the key information table [T-2].

If there is a hidden key (YES in Step #132), the mode setting process for this case is executed in Step #133. Meanwhile, if there is no hidden key in Step #132 (NO in Step #132), the regular mode setting process is executed (Step #134). As described above, the existence of a hidden key affects the judgment which mode setting process to go with.

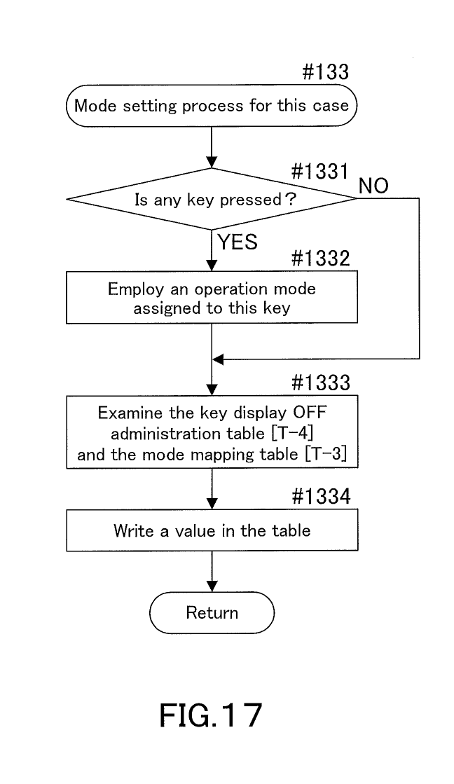

FIG. 17 is a flowchart representing a subroutine that is the mode setting process of Step #133 in Step #16, which is executed if there is a hidden key.

In Step #1331, it is judged whether or not any operation key is pressed. If any operation key is pressed (YES in Step #1331), an operation mode assigned to this operation key is employed in Step #1332. After that, the subroutine goes to Step #1333. If no operation key is pressed (NO in Step #1331), the subroutine directly goes to Step #1333.

In Step #1333, a value is determined according to the key display OFF mode management table [T-4] and the mode mapping table [T-3], and in Step #1334, the determined value is written into the mode mapping table [T-3]. And then, the subroutine returns to the main routine.

For example, if an operation key for setting the 2-in-1 mode is pressed, a value of scale is determined according to the scale table [T-4(2)] included in the key display OFF mode management table [T-4] as illustrated in FIG. 8. Meanwhile, if an operation key for setting the book style document mode is pressed, a value of original image quality is determined according to the original image quality table [T-4(3)]. And then, the determined value is written into the mode mapping table [T-3].

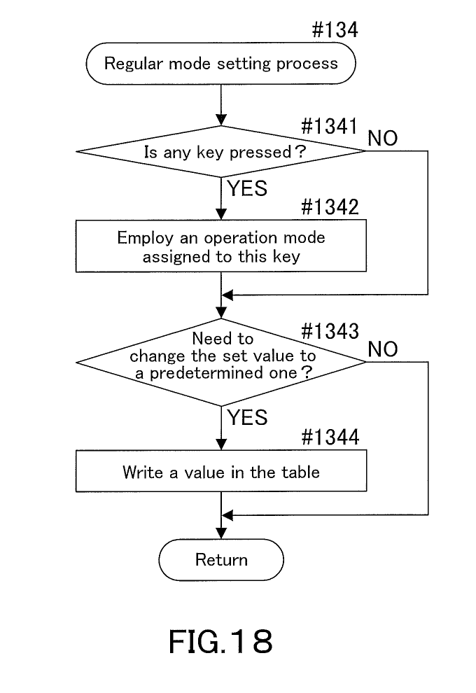

FIG. 18 is a flowchart representing a subroutine that is the regular mode setting process of Step #134 in FIG. 16.

In Step #1341, it is judged whether or not any operation key is pressed. If any operation key is pressed (YES in Step #1341), an operation mode assigned to this operation key is employed in Step #1342. After that, the subroutine goes to Step #1343. If no operation key is pressed (NO in Step #1341), the subroutine directly goes to Step #1343.

In Step #1343, it is judged whether or not the set value has to be changed to a predetermined one according to the key information table [T-2]. If it has to be changed to a predetermined value (YES in Step #1343), it is rewritten with the predetermined value, and thereby the mode mapping table [T-3] is updated in Step #1344. After that, the subroutine returns to the main routine. If the set value does not have to be changed (NO in Step #1343), the subroutine immediately returns to the main routine.

For example, if an operation key for setting the 2-in-1 mode is pressed, the set value of scale is changed to a predetermined one according to the key information table [T-2] of FIG. 6, and similarly, if an operation key for setting the book style document mode is pressed, the set value of original image quality is changed to a predetermined one according to this table.

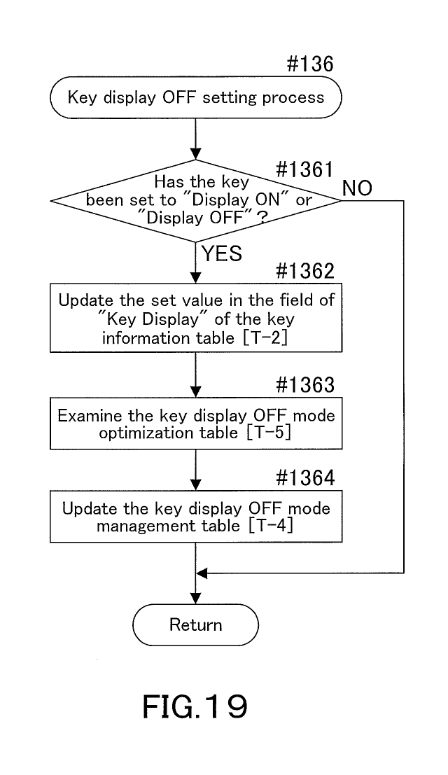

FIG. 19 is a flowchart representing a subroutine that is the key display OFF setting process of Step #136 in FIG. 16.

In Step #1361, it is judged whether or not the operation key has been set to “Display ON” or “Display OFF” (NO in Step #1361). If it has not been set to “Display ON” or “Display OFF”, the subroutine immediately returns to the main routine. If the operation key has been set to “Display ON” or “Display OFF” (YES in Step #1361), the set value in the field of “Key Display” of the key information table [T-2] is rewritten accordingly, in Step #1362. After that, the key display OFF mode optimization table [T-4] is examined in Step #1363, and the key display OFF mode management table [T-4] is updated in Step #1364.

If the operation key has been set to OFF, default values are copied from the program ROM 25. If the practical state of setting matches any one of the key display OFF mode optimization table [T-5], it is fed back to the key display OFF mode management table [T-4].

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
a display;
a customization portion that allows performing customization so that one or more than one operation key for setting an operation mode will or will not appear on the display;
a mode setting portion that allows employing operation modes including a first operation mode, and a second operation mode forcibly canceling a value set for the first operation mode; and
a controller that forcibly changes the value set for the first operation mode to a first parameter, still keeps the first parameter after cancellation of the second operation mode, and changes the first parameter according to a user operation, if the second operation mode is employed by the mode setting portion while an operation key for setting a value for the first operation mode is not hidden by the customization portion, meanwhile changes the value set for the first operation mode to a second parameter and changes the second parameter to a third parameter after cancellation of the second operation mode, if the second operation mode is employed by the mode setting portion while an operation key for setting a value for the first operation mode is hidden by the customization portion.

2. The image processing apparatus as recited in claim 1 further comprising a memory that stores parameter information, in which the second parameter, the third parameter, and the operation mode are connected to each other, and wherein, while the operation key for setting a value for the first operation mode is hidden, the controller changes the value set for the first operation mode to a parameter set for the operation mode currently employed by the mode setting portion according to the parameter information stored on the memory.

3. The image processing apparatus as recited in claim 1, wherein the first operation mode is for setting the scale of image, and the second operation mode is for reducing the size of images on a plurality of pages of a document so that those can be printed out perfectly on one sheet of paper.

4. The image processing apparatus as recited in claim 1, wherein the first operation mode is for setting the original image quality, and the second operation mode is for setting the document reading mode.

5. An operation mode setting method for an image processing apparatus comprising:
performing customization so that one or more than one operation key for setting an operation mode will or will not appear on a display;
employing operation modes including a first operation mode, and a second operation mode forcibly cancelling the value set for the first operation mode; and
forcibly changing the value set for the first operation mode to a first parameter, still keeping the first parameter after cancellation of the second operation mode, and changing the first parameter according to a user operation, if the second operation mode is employed while an operation key for setting a value for the first operation mode is not hidden, meanwhile changing the value set for the first operation mode to a second parameter and changing the second parameter to a third parameter after cancellation of the second operation mode, if the second operation mode is employed while an operation key for setting a value for the first operation mode is hidden.

6. The operation mode setting method as recited in claim 5, wherein the value set for the first operation mode is changed to a parameter set for the currently-employed operation mode according to parameter information stored on a memory, in which the second parameter, the third parameter, and the operation mode are connected to each other, while the operation key for setting a value for the first operation mode is hidden.

7. The operation mode setting method as recited in claim 5, wherein the first operation mode is for setting the scale of image, and the second operation mode is for reducing the size of images on a plurality of pages of a document so that those can be printed out perfectly on one sheet of paper.

8. The operation mode setting method recited in claim 5, wherein the first operation mode is for setting the original image quality, and the second operation mode is for setting the document reading mode.

9. A computer-readable recording medium having an operation mode program recorded thereon to make a computer of an image processing apparatus execute:
performing customization so that one or more than one operation key for setting an operation mode will or will not appear on a display;
employing operation modes including a first operation mode, and a second operation mode forcibly cancelling the value set for the first operation mode; and
forcibly changing the value set for the first operation mode to a first parameter, still keeping the first parameter after cancellation of the second operation mode, and changing the first parameter according to a user operation, if the second operation mode is employed while an operation key for setting a value for the first operation mode is not hidden, meanwhile changing the value set for the first operation mode to a second parameter and changing the second parameter to a third parameter after cancellation of the second operation mode, if the second operation mode is employed while an operation key for setting a value for the first operation mode is hidden.

10. The computer-readable recording medium having an operation program recorded thereon to make a computer of an image processing apparatus execute processing, as recited in claim 9, wherein the value set for the first operation mode is changed to a parameter set for the currently-employed operation mode according to parameter information stored on a memory, in which the second parameter, the third parameter, and the operation mode are connected to each other, while the operation key for setting a value for the first operation mode is hidden.

11. The computer-readable recording medium having an operation mode setting program stored thereon, as recited in claim 9, wherein the first operation mode is for setting the scale of image, and the second operation mode is for reducing the size of images on a plurality of pages of a document so that those can be printed out perfectly on one sheet of paper.

12. The computer-readable recording medium having an operation mode setting program stored thereon, as recited in claim 9, wherein the first operation mode is for setting the original image quality, and the second operation mode is for setting the document reading mode.
